(19) United States
(12) Patent Application Publication
(10) Pub. No.: US 2005/0269262 A1
(43) Pub. Date: Dec. 8, 2005

(54) Biological film support module for wastewater treatment system

(75) Inventor: Jeffrey T. McBride, Salt Lake City, UT (US)

Correspondence Address: R. Neil Sudol, 714 Colorado Avenue, Bridgeport, CT, 06605, US

(73) Assignee: GL&V Management Hungary kft.

(21) Appl. No.: 10/858,914

(22) Filed: Jun. 2, 2004

(51) Int. Cl. C02F 3/00

(52) U.S. Cl. 210/615; 210/150; 210/242.2

(57) ABSTRACT

In a biological film module for wastewater treatment system, a frame for supporting porous biological-growth support media is provided with at least one pontoon float. Also disposed on the frame is an aerator in the form of a removable diffused aeration grid including a plurality of individual diffusers disposed in a rectangular planar array.

### BACKGROUND OF THE INVENTION

This invention relates to a biological film support module for wastewater treatment systems. This invention also relates to an associated method.

An integrated fixed-film activated sludge (IFAS) system is a hybrid wastewater treatment system that combines attached biological growth with suspended biological growth to provide a more efficient wastewater treatment system. IFAS systems immerse solid support media in a basin having suspended biological growth. The support media serve to promote attached or fixed biological growth.

IFAS systems are often used to upgrade continuous plug flow reactor systems. Over the past few years there have been improvements in the viability of these systems. One recent improvement in this area is the use of textile sheets supported on a frame assembly that is immersed in an activated sludge basin or tank.

### SUMMARY OF THE INVENTION

The present invention is directed to providing further improvements in IFAS systems. The present invention seeks to solve problems of efficiency and ease of installation and repair.

A biological film support module for wastewater treatment systems comprises, in accordance with the present invention, a frame for supporting biological-growth support media and at least one pontoon float attached to the frame for suspending the frame, together with biological-growth support media, in a wastewater treatment tank.

The frame may be made of 304L stainless steel structural tubing of variable dimensions.

The pontoon may take any form that enables the floating of the media support frame in a sludge mass. Thus, the pontoon may be a hollow body made of metal or plastic or any other effectively water-impermeable material. The hollow body may be rigid as in the case of metal or resilient as in the case of an inflatable balloon member. Alternatively, the pontoon may be partially or mainly made of a closed cell foam material. In the latter event, the pontoon may be encased in a stainless steel skin.

The pontoon may be one of a plurality of pontoons attached to the frame. Preferably, the plural pontoons are attached to an upper end of the frame and are positioned away from the center of gravity of the entire biological film module to maximize buoyant stability while the unit is floating. In addition, the pontoons are preferably sized to float the entire modular assembly plus at least one person.

Pursuant to another feature of the present invention, the module further comprises an aerator disposed on the frame. The aerator preferably takes the form of a diffused aeration grid including a plurality of individual diffusers disposed, for example, in a rectangular planar array.

Pursuant to a further feature of the present invention, the module also comprises means on the frame for feeding an oxygen-containing gas to the aerator. Specifically, a blower may be mounted to the frame (generally above the water line), the blower being operatively connected to the diffused aeration grid via drop-leg piping and a manifold.

In accordance with additional features of the present invention, the diffused aeration grid is releasably attached to the frame at a lower end thereof, while biological-growth support media are removably attached to the frame. The biological-growth support media may take the form of multiple textile sheets arranged in parallel planes to each other. The sheets may be attached to the frame at a manufacturing plant or, alternatively, at the site of installation.

The frame may be provided with supports for enhancing a standing capability of the frame. The supports include outward extensions at a lower end of the frame. The extensions buttress the stability of the frame on a horizontal support surface outside of a wasterwater treatment tank.

A biological film support module for wastewater treatment system comprises, in accordance with the present invention, a float and means coupled to the float for suspending biological-growth support media from the float. The suspension means may take the form of a frame and/or connectors such as clamps, hooks, and bolts.

Pursuant to further features of the present invention, the biological film support module further comprises an aerator suspended from the float for feeding oxygen-containing bubbles to a treatable aqueous liquor in which the biological-growth support media is suspended, and optionally a blower mounted at least indirectly to the float for feeding an oxygen-containing gas to the aerator. The aerator may be releasably attached at least indirectly to the float.

A method for enhancing operational efficacy of a water treatment system comprises, in accordance with the present invention providing a frame for supporting biological-growth support media, and floating the frame, together with biological-growth support media, in a body of treatable water.

The method may additionally comprise suspending an aerator from the frame so that the aerator is disposed in the body of treatable water and feeding air to the aerator during treatment of the treatable water. The air may be fed to the aerator by operating a blower disposed on the frame.

Where the aerator is releasably secured to the frame, the method may further comprise removing the frame from the body of treatable water, detaching the aerator from the removed frame, and floating the frame again on the body of treatable water.

Where the frame has at least one pontoon float, the floating of the frame includes placing the pontoon on the body of treatable water.

The present invention provides a floating modular fixed-film support assembly that may be used in both lagoon and sequencing batch reactor (SBR) applications. Floating modular fixed-film support assemblies in accordance with the present invention may be used to upgrade existing lagoon and SBR facilities, as well as to enhance new wastewater treatment installations.

Because a modular fixed-film support assembly in accordance with the present invention is supported in a sludge containing tank by one or more floats, the entire assembly may be easily removed for repair purposes. Inasmuch as the diffused aeration grid in turn is attachable to the module's frame by quick-release couplings, the grid may be easily repaired or replaced.

As noted above, a floating modular fixed-film support assembly in accordance with the present invention may carry its own blower. Thus, the entire assembly may be an integrated self-sustaining unit that does not require coupling to external sources of energy or pressurized air.

The integrated modular characteristic of floating fixed-film support assemblies in accordance with the present invention facilitates the design and building of new wastewater treatment plants, as well as the upgrading of existing installations. This result is especially evident in SBR applications, where liquid level varies in accordance with time in an operating cycle. A floating fixed-film support unit rises and falls with the liquid level and thus presents a maximized biological growth-support area for a given structure size.

### BRIEF DESCRIPTION OF THE DRAWINGS

FIG. 1 is a schematic perspective view of a biological film support module for wastewater treatment systems, showing the module without attached biological growth support media.

FIG. 2 is a schematic perspective view similar to FIG. 1, showing the biological film support module with attached biological growth support media.

FIG. 3 is a schematic top plan view of a lagoon-type wastewater treatment system with multiple biological film support modules as illustrated in FIGS. 1 and 2.

FIG. 4 is a schematic vertical cross-sectional view of the system of FIG. 3, taken along line IV-IV in FIG. 3.

FIG. 5 is a schematic top plan view of successive stages in the operation of an SBR-type wastewater treatment system with multiple biological film support modules as illustrated in FIGS. 1 and 2.

FIG. 6 is a schematic vertical cross-sectional view of the stages of operation of FIG. 5.

### DETAILED DESCRIPTION OF THE PREFERRED EMBODIMENT

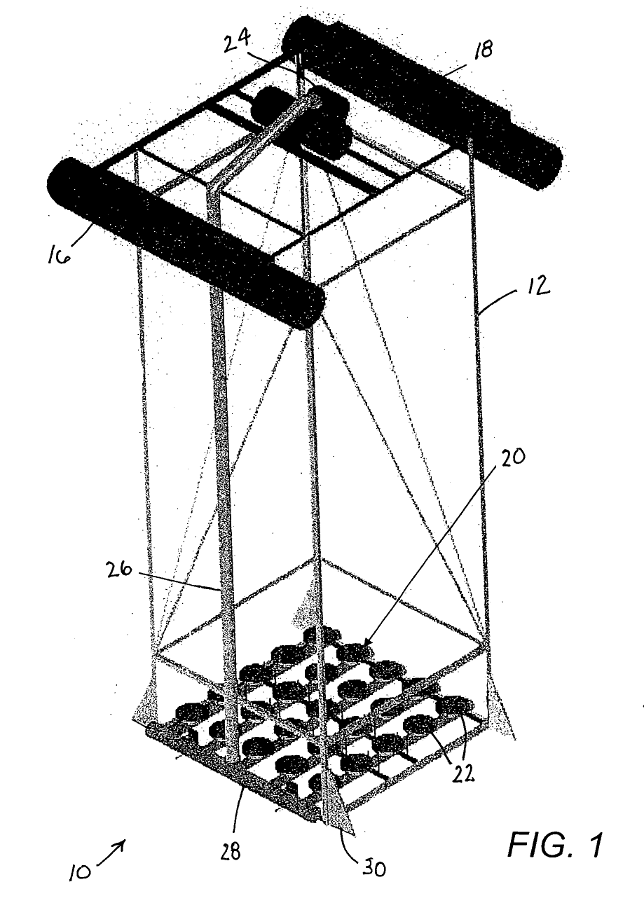

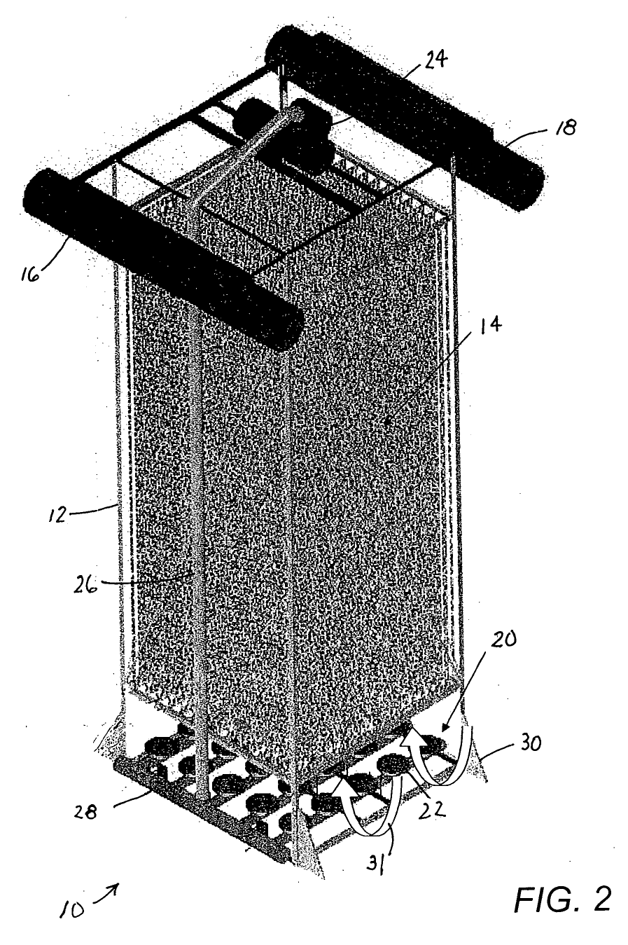

As depicted in FIGS. 1 and 2, a biological film support module 10 for a wastewater treatment system comprises a frame 12 for supporting porous biological-growth support media in the form of textile sheets 14. The support module 10 further comprises a pair of pontoon floats 16 and 18 attached to frame 12 for suspending the frame, together with the porous biological-growth sheets 14, in a wastewater treatment tank.

Frame 12 is made of 304L stainless steel structural tubing of variable dimensions. Pontoon floats 16 and 18 comprise a 304L stainless steel skin with a closed cell foam filler material. Pontoon floats 16 and 18 are attached to an upper end of frame 12 and are positioned away from the center of gravity of the entire biological film module 10 to maximize buoyant stability while the unit is floating. Pontoons 16 and 18 are preferably sized to float the entire modular assembly plus at least one person.

Module 10 further comprises an aerator 20 disposed on frame 12 at a lower end thereof. Aerator 20 takes the form of a diffused aeration grid including a plurality of individual diffusers 22 disposed in a rectangular planar array. Diffusers 22 are fine bubble diffusers with EPDM membranes. Diffusers 22 may specifically take the form of disks, tubes, or panels and preferably maintain a low profile.

Diffused aeration grid 20 is removably attached to frame 12, via quick-release couplings (not illustrated) to facilitate rapid repair and replacement procedures.

Module 10 further comprises a blower 24, such as a rotary lobe PD blower of 5 to 15 horsepower, mounted to frame 12 at an upper end thereof, above the water line of the module, for feeding an oxygen-containing gas to diffused aeration grid 20. Blower 24 is connected to diffusers 22 via drop-leg piping 26 and a manifold 28. Piping 26 is made of stainless steel to provide rigidity and maximize heat transfer, while manifold 28 is made of CPVC or PVC piping 4 to 6 inches in diameter and with headers 4 inches in diameter.

Frame 12 is provided with triangular leg extensions 30 for buttressing the standing capability of the frame. Extensions 30 project outwardly at a lower end of frame 12. The extensions enhance the stability of frame 12 on a horizontal surface (not shown) outside of a wasterwater treatment tank.

Microbial-growth support sheets 14 (FIG. 2) are removably attached to frame 12. Sheets 14 are arranged in parallel planes relative to each other. Sheets 14 may take the form of textile sheets which have a construction that minimizes clogging and promotes multidirectional mass transfer of oxygen as nutrients to the biomass attached to the sheets. This reduces overall oxygen demand and enhances efficiency. Sheets 14 may be attached to frame 12 during manufacture or subsequently at an installation site.

Each textile sheet 14 may be removed individually for maintenance. Preferably, sheets 14 are oriented in vertical planes for enhancing aeration effectiveness while facilitating removal from frame 12.

Diffused aeration grid 20 is attached to an undercarriage of frame 12 below textile sheets 14. This maximizes contact between dissolved oxygen and active biomass. Air bubbles rising from grid 20 generate an overall upward flow through the biological-growth media, i.e., sheets 14. This in turn induces suspended solids to flow from the bottom and outside of module 10 up and through sheets 14. During a wastewater treatment process, modules 10 and particularly blowers 24 and diffused aeration grids 20 thereof are operational to circulate sludge through textile sheets 14, as indicated by arrows 31.

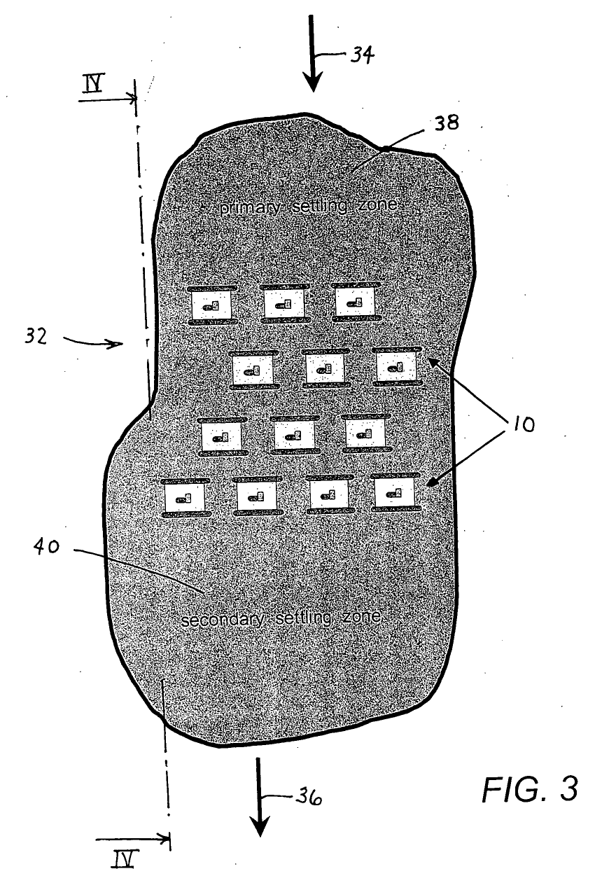

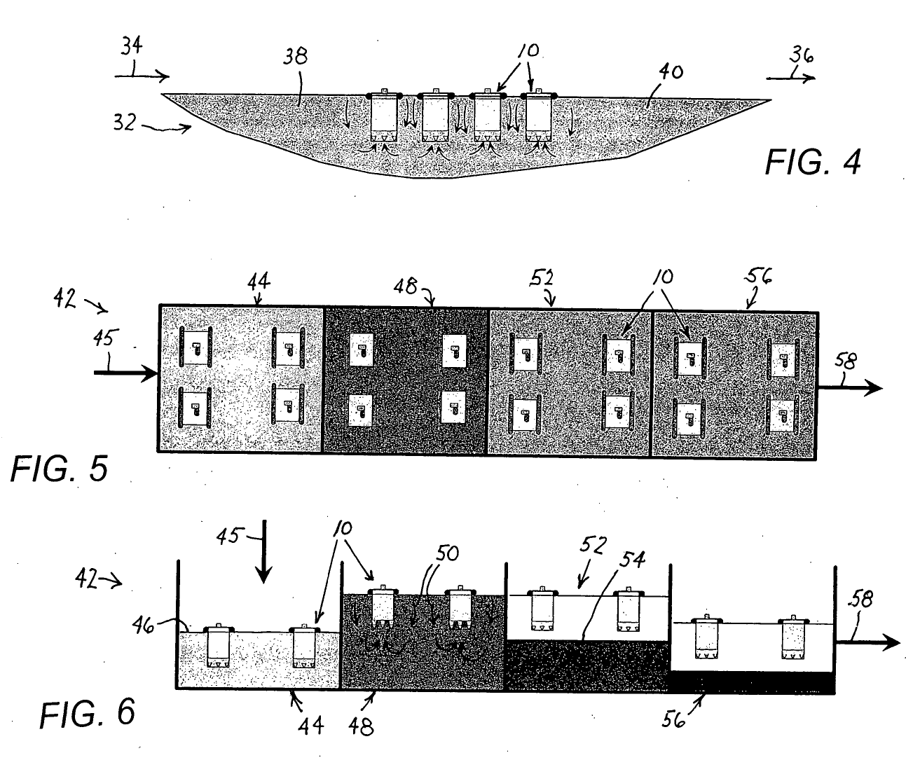

As illustrated in FIGS. 3 and 4, a lagoon-type wastewater treatment system 32 may be provided with a plurality of biological-growth support modules 10. Where wastewater flows along a path from an influent direction 34 to an effluent direction 36, modules 10 are disposed between a primary settling zone 38 and a secondary settling zone 40. Modules 10 enable a ready upgrade of a lagoon-type wastewater treatment system to an IFAS system, with minimal modifications. Modules 10 may be easily removed for maintenance.

As shown in FIGS. 5 and 6, a sequencing batch reactor 42 may be provided with a plurality of biological-growth support modules 10. During a fill cycle 44 of a batch treatment process, wastewater enters as influent 45. Typically modules 10 float in a residual or initial fill level 46 at the commencement of the fill cycle 44. During a react cycle 48 of the batch treatment process, modules 10 and particularly blowers 24 and diffused aeration grids 20 thereof are operational to circulate sludge through textile sheets 14, as indicated by arrows 50. During a subsequent settle cycle 52, blowers 24 and grids 20 are inactive, allowing the settling of solids 54 to the bottom of the SBR tank. In a decant cycle 56, effluent is drawn off, as indicated by an arrow 58.

Floating modules 10 accommodate different water depths. This is especially useful in SBR systems. Floating modules 10 allow extreme ease of installation so that an SBR facility can be readily upgraded to an IFAS system with minimal modifications. Modules 10 may incorporate respective, individual blowers 24 or be tied to an air main.

Although the invention has been described in terms of particular embodiments and applications, one of ordinary skill in the art, in light of this teaching, can generate additional embodiments and modifications without departing from the spirit of or exceeding the scope of the claimed invention. For example, instead of separate pontoons attached to the frame, the frame may incorporate floatable componentry into its structure. Thus, the frame elements may be hollow floatable structural members or may incorporate floatable material such as closed cell foam filler. In addition, the aerator may take a form other than a grid, such as an impeller with air-exit apertures along the blade(s). In some applications, the function of blower 24 may be performed off-module, with a conduit extending to piping 26 or manifold 28 from another module or from a location on or outside of the wastewater treatment tank.

Accordingly, it is to be understood that the drawings and descriptions herein are proffered by way of example to facilitate comprehension of the invention and should not be construed to limit the scope thereof.

1. A biological film support module for wastewater treatment system, comprising:
a frame for supporting biological-growth support media; and
at least one pontoon float attached to said frame for suspending said frame, together with biological-growth support media, in a wastewater treatment tank.

2. The module defined in claim 1, further comprising an aerator disposed on said frame.

3. The module defined in claim 2 wherein said aerator is a diffused aeration grid.

4. The module defined in claim 3 wherein said grid includes a plurality of individual diffusers disposed in an array.

5. The module defined in claim 4 wherein said array is a planar array.

6. The module defined in claim 5 wherein said array is a rectangular array.

7. The module defined in claim 3 wherein said pontoon float is attached to an upper end of said frame.

8. The module defined in claim 7 wherein said pontoon float is one of a plurality of spaced pontoon floats attached to said frame at said upper end.

9. The module defined in claim 3, further comprising means on said frame for feeding an oxygen-containing gas to said grid.

10. The module defined in claim 6 wherein said means for feeding includes a blower mounted to said frame and further includes piping extending from said blower to said grid.

11. The module defined in claim 2, further comprising means on said frame for feeding an oxygen-containing gas to said aerator.

12. The module defined in claim 11 wherein said means for feeding includes a blower mounted to said frame and further includes piping extending from said blower to said aerator.

13. The module defined in claim 2 wherein said aerator is releasably attached to said frame.

14. The module defined in claim 2 wherein said aerator is disposed at a lower end of said frame.

15. The module defined in claim 1, further comprising biological-growth support media attached to said frame.

16. The module defined in claim 15 wherein said biological-growth support media is removably mounted to said frame.

17. The module defined in claim 15 wherein said biological-growth support media include multiple textile sheets.

18. The module defined in claim 1 wherein said pontoon float is attached to an upper end of said frame.

19. The module defined in claim 18 wherein said pontoon float is one of a plurality of spaced pontoon floats attached to said frame at said upper end.

20. The module defined in claim 1 wherein said frame is provided with supports for enhancing a standing capability of said frame.

21. The module defined in claim 20 wherein said supports include outward extensions at a lower end of said frame.

22. The module defined in claim 1 wherein said pontoon float has a body of a closed cell foam material.

23. A biological film support module for wastewater treatment system, comprising:
a float; and
means coupled to said float for suspending biological-growth support media from said float.

24. The module defined in claim 23, further comprising an aerator suspended from said float for feeding oxygen-containing bubbles to a treatable aqueous liquor in which said biological-growth support media is suspended.

25. The module defined in claim 24, further comprising a blower mounted at least indirectly to said float for feeding an oxygen-containing gas to said aerator.

26. The module defined in claim 24 wherein said aerator is releasably attached at least indirectly to said float.

27. The module defined in claim 23 wherein said means for suspending includes a frame.

28. The module defined in claim 27, further comprising biological-growth support media attached to said frame.

29. The module defined in claim 27 wherein said float is attached to an upper end of said frame.

30. A method for enhancing operational efficacy of a water treatment system, comprising:
providing a frame for supporting biological-growth support media; and
floating said frame, together with biological-growth support media, in a body of treatable water.

31. The method defined in claim 30, further comprising:
suspending an aerator from said frame so that said aerator is disposed in said body of treatable water; and
feeding air to said aerator during treatment of said treatable water.

32. The method defined in claim 31 wherein the feeding of air to said aerator includes operating a blower disposed on said frame.

33. The method defined in claim 32, further comprising:
removing said frame from said body of treatable water;
detaching said aerator from the removed frame; and
floating said frame again on said body of treatable water.

34. The method defined in claim 30 wherein said frame has at least one pontoon float, the floating of said frame including placing said pontoon on said body of treatable water.
